(19) United States
(12) Patent Application Publication
(10) Pub. No.: US 2013/0240804 A1
(43) Pub. Date: Sep. 19, 2013

(54) SILICONE MATERIAL HAVING A PHOTOCHROMIC ADDITIVE

(71) Applicant: CANOPY VALLEY LLC, Milpitas, CA (US)

(72) Inventors: Allan D. Pagba, Milpitas, CA (US); Gary K. Wong, San Jose, CA (US)

(73) Assignee: Canopy Valley LLC, Milpitas, CA (US)

(21) Appl. No.: 13/864,712

(22) Filed: Apr. 17, 2013

Related U.S. Application Data
(63) Continuation of application No. PCT/US13/32689, filed on Mar. 15, 2013.
(60) Provisional application No. 61/611,578, filed on Mar. 16, 2012.

(51) Int. Cl. G02B 1/04

(52) U.S. Cl. CPC G02B 1/04
USPC 252/586

(57) ABSTRACT

A silicone-based material that incorporates a photochromic molecule, and methods of making the same. The material changes color when exposed to ultraviolet radiation, thereby providing a convenient indicator of exposure. The material reverts to its original color after the source of ultraviolet radiation is removed. Compositions and articles that comprise a silicone-based material that incorporates a photochromic dye.

### CLAIM OF PRIORITY

This application is a continuation of international application Ser. No. PCT/US13/32689, filed Mar. 15, 2013, which claims the benefit of priority under 35 U.S.C. §119(e) to U.S. provisional application Ser. No. 61/611,578, filed Mar. 16, 2012, both of which are incorporated herein by reference in their entireties.

### TECHNICAL FIELD

The technology described herein generally relates to materials containing a photochromic substance that effects a color change on exposure to UV light, and more particularly relates to a silicone-based material that incorporates a photochromic molecule such as a dye.

### BACKGROUND

Photochromic molecules undergo reversible changes in color on exposure to light. Once the molecule has changed from one state to another after absorbing a photon, it will relax back to the first state over some period of time. Usually the change in color is accompanied by a change in the molecule's structure that causes one form to have a different absorption spectrum from the other. Of particular interest are those photochromic molecules that are caused to change from one state to another by the impact of ultraviolet radiation because ultraviolet radiation is invisible to the human eye, yet can be damaging to materials and human skin over long periods of time.

Photochromic molecules may degrade over time, due to exposure to oxygen in the air and/or other free radicals. Incorporation of the molecules into a matrix, for example made from an organic polymer, can prolong their useful lifetime, however.

Although photochromic molecules and other dyestuffs have long been used in the plastics industry, the inclusion of colored substances into silicone based materials has been limited. This is due in large part to practical difficulties in obtaining effective cooperation between organic molecule dyes and the inorganic material silicones. Silicones typically require a curing step when making a solid object from them; the presence of other materials can interfere with the curing process. Alternatively, the curing process can have the effect of degrading a number of organic dyes.

Nevertheless, silicones are useful substances for making a variety of materials, and have numerous applications. They have low toxicity, are largely inert, are very durable, heat-resistant, have low thermal conductivity, and can also be flexible, many of them having rubber-like properties. Other of their properties make them suitable in a variety of applications, including: building construction, as thermal insulators such as in firestops; in automotive applications such as spark plug wires and brake lubricants; as sealants, for example in pools, aquariums, and in plumbing, and as caulking agents used in kitchens and bathrooms; as coatings, as used in ophthalmology; in domestic articles, such as cookware, toys, and items of personal care; in liquid form as defoaming agents, dry cleaning chemicals, lubricants, as insulators for electronics; in devices used in medicine, in part because silicones do not support microbial growth; and in mold-making.

Of particular importance to the applications herein, silicones are largely UV-resistant, meaning that they can withstand long exposures to ultraviolet radiation without experiencing degradation in appearance or form. This contrasts with many plastics, which, after long exposures to the sun will discolor and may also deteriorate appreciably.

The discussion of the background herein is included to explain the context of the technology. This is not to be taken as an admission that any of the material referred to was published, known, or part of the common general knowledge as at the priority date of any of the claims found appended hereto.

Throughout the description and claims of the application the word “comprise” and variations thereof, such as “comprising” and “comprises”, is not intended to exclude other additives, components, integers or steps.

### SUMMARY

The instant disclosure addresses materials that comprise a photochromic substance within a silicone, and can act as indicators of exposure to ultraviolet light. The present disclosure further includes methods of making the materials.

The technology herein includes compositions of two components, a silicone and a photochromic dye, that together provide a material that has the expected physical and chemical characteristics of silicone but can also display a color change when exposed to ultraviolet, specifically UV-A and UV-B, light. The usefulness of the compositions in many different applications and possibilities are limited principally by the physical characteristics of the material. For example, the materials described herein find utility by giving a silicone based material the ability to detect and alert a holder or user of any exposure to UV radiation that the material—and consequently the user—is experiencing.

With the technology described herein, silicone is used as a substrate or matrix for the photochromic dye to be applied, inserted, or integrated. Thus it can provide a silicone-based application having the added characteristics of UV radiation detection.

### DETAILED DESCRIPTION

The instant technology is directed to a material comprising silicone and a photochromic dye. Such a material shares the physical and chemical properties of silicone and additionally has the ability to detect UV radiation exposure. It improves or adds UV reactivity characteristics to the silicone or silicone based material.

A photochromic molecule combined together with silicone or any silicone based material creates a photochromic silicone material that will change color when exposed to UV radiation and near-UV radiation with wavelengths between 250 nm and 600 nm. This adds UV reaction/detection characteristics to the silicone to provide a material that can then be shaped or molded into many different applications according to its hardness, just as other silicones can.

The materials described herein can be used in many different applications, for example, based on current applications of both silicone materials and other materials that contain reversible photochromic substances. Such applications include, but are not limited to, bracelets, charms, tattoos, stickers, logos, and sporting goods that are often made from silicones or contain silicone components. With the variety of silicone materials available, the end products may take on such diverse consistencies as hard plastic, rubber, gels, and even liquids. Reversible photochromics can already be found in products such as toys, cosmetics, and clothing, as well as in industrial applications. By combining them with silicone materials, their range and variety of application can be extended considerably.

The components of the material described herein are as follows:

1. A photochromic dye. Pure photochromic dyes usually have the appearance of a crystalline powder, and in order to achieve the color change, they usually have to be dissolved in a solvent or dispersed in a vehicle (such as an emulsion) for application. Once dissolved they are usually applied to a substrate or matrix.

2. Silicone material. Silicones are poly-siloxanes. A silicone material is the substrate or matrix into which the photochromic dye is mixed.

Together the two components create a material that has the durability characteristics of silicone, and the added ability to react by color change when exposed to UV-A and/or UV-B radiation.

Silicone rubbers and resins generally result from a catalytic curing process applied to a silicone precursor molecule. The instant photochromic material is typically made by introducing a quantity of the photochromic substance, for example in solution, into the silicone/catalyst mixture while the silicone is being cured. The resulting mixture is caused to become homogeneous during the curing process, for example by stirring or shaking the vessel. It is important to keep the mixture containing the photochromic substance away from exposure to UV during the curing/mixing process.

It is to be understood that the resulting chemical association between the photochromic molecule and the silicone material can take many different forms, depending on the nature (side-chains, and cross-linking) of the silicone precursor and the resulting silicone matrix, and the type of photochromic molecule. As referenced elsewhere herein, many organic photochromic molecules have very low affinity for the inorganic silicones. Therefore the two components mix only with difficulty. While the possibility of a chemical reaction between the photochromic molecules and the silicone molecules during the curing and mixing process cannot be ruled out, generally the resulting material contains the two materials uniformly interspersed with one another. Thus, in many instances, the photochromic molecule does not end up chemically bonded to the silicone molecules but instead retains its own chemical identity and is incorporated within the physical structure defined by the silicones. In this way, the photochromic molecule can be considered to be hosted within a matrix defined by the surrounding silicone. It can also be described variously as being incorporated within, impregnated into, mixed into, absorbed into, diffused within, and interspersed within, the silicone matrix. To the extent that the photochromic molecule itself undergoes a structural, such as conformational, change when irradiated with UV light, that structural change should not be impeded by the surrounding silicone in a manner that either inhibits the reversible nature of the photochromic change or stops a color change taking place. To that extent, the interaction between the photochromic molecules and the surrounding silicone structure is typically characterized as weak, such as through electrostatic or van der Waals forces. In some instances, the interaction may still be sufficient to alter the absorption spectrum of the photochromic molecule in one of its two forms relative to its spectrum in its pure (solid) state, or in solution in water or an organic solvent. Thus, a photochromic molecule that has a known color in its pure form may change to a different color when introduced into the silicone, even before it has undergone a change due to the impact of UV light. In some instances, one or more covalent bonds may be formed between the photochromic molecule and one or more of the surrounding silicone moieties. Whether this happens will depend on the photochromic molecule and also the type of silicone deployed. In such instances, the resulting material will only exhibit photochromic properties if the original photochromic molecule is still able to react to UV light, while chemically bound, in such a way that it evinces a color change.

The photochromic molecules in question typically have a lifetime limited to 50,000 changes. Correspondingly, the actual lifetime of the material depends on how frequently it is exposed to UV. In the case of many short rapid exposures, the material may only be functional for as short a time as a month.

The material described herein can be produced or moulded in a variety of shapes and configurations. In particular, it may be prepared as a thin film, e.g., for windows of cars, (e.g., for baby shades), and spectacles. Such films would preferably be removable so that they could easily be changed at the end of their useful operating lives.

The materials herein can also be used in conjunction with silicone-impregnated nylon, often referred to as “silnylon”. See, for example: U.S. Pat. No. 7,406,977. In such an embodiment, the photochromic molecule is applied to the underside layer of an article such as an umbrella (which comprises 2 layers of material). The upper layer comprises silicones integrated with nylon fibers.

### Silicones

Most plastics contain organic, i.e., carbon-based, polymers. The vast majority of these polymers are based on chains of carbon atoms alone or may additionally contain atoms of oxygen, sulfur, or nitrogen, within the chains or in side groups. The balance is provided by hydrogen. The chains comprise a large number of repeat units linked together to form a backbone. To customize the properties of a plastic, different molecular groups “hang” from the backbone (usually they are incorporated as part of the monomers before the monomers are linked together to form the chain). The structure of these side chains influences the properties of the polymer.

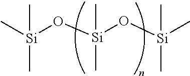

Silicones, or polysiloxanes, as used with the materials described herein, differ from predominantly carbon-based polymers in that their backbones consist of Si—O—Si units. The repeating unit is (R₂SiO), where R is some side-group, usually an organic group such as an alkyl, or a phenyl group. Variations in properties are achieved in three ways: by varying R, by varying chain length, and by permitting cross-linking between chains to create two-dimensional networks, or three-dimensional cages. The last variation, linking between the polysiloxane chains, often gives rise to materials that are resins. Silicone resins have the general formula RₙSiXₘO_{y}, where X may be hydrogen or a functional group such as OH, Cl or OR. Silicone chemistry generally is described in, e.g., “Silicone Chemistry Overview”, 1997, Dow Corning Technical Library, MI, USA (www.dowcorning.com/applications/search/content/default.aspx?WT.svl=1), incorporated herein by reference.

Polysiloxane materials are very flexible, due in part to large bond angles and long bond lengths between their constituent atoms, when compared to those found in organic polymers such as polyethylene. For example, a C—C backbone unit, as in polyethylene, has a bond length of 1.54 Å and a bond angle of 112°, whereas the siloxane backbone unit Si—O has a bond length of 1.63 Å and an Si—O—Si bond angle of 130°. Because the bond lengths of siloxane units are longer than carbon-carbon units, they can move farther and change conformation more easily, giving rise to a flexible material.

Polysiloxanes also tend to be chemically inert, due to the strength of the silicon-oxygen bond. Despite silicon being a congener of carbon, silicon analogues of carbonaceous compounds generally exhibit markedly different chemical properties, due to the differences in electronic structure and electronegativity between the two elements. The silicon-oxygen bond in polysiloxanes is significantly more stable than the carbon-oxygen bond in polyoxymethylene (a structurally similar polymer) due to its higher bond energy.

Polydimethylsiloxane (PDMS, i.e., a polysiloxane in which R═CH₃) is the most widely used silicone. PDMS is optically clear, and, in general, is considered to be inert, non-toxic and non-flammable. The chemical formula for PDMS is CH₃[Si(CH₃)₂O]ₙSi(CH₃)₃, where n is the number of repeating monomer [SiO(CH₃)₂] units. Synthesis can begin from dimethylchlorosilane and water according to the net reaction:

n Si(CH₃)₂Cl₂+n H₂O→[Si(CH₃)₂O]ₙ+2n HCl.

Silicones are available having a variety of properties, such as opacity (some are clear, some translucent), hardness (as measured by Shore hardness indices in the range 0-80), and grade (for example, approved for certain uses, such as culinary, or medical use).

Shore hardness indices, on the A scale, in the range 30-40 indicate a soft malleable material; an index of 15 is like jello; an index in the range 60-70 is like an eraser. Shore hardness guidelines for a silicone rubber are found at: www.freemansupply.com/techlibrary/shorehardness.htm. Shore hardness comes from a durometer scale, of which different scales are used for materials with different properties. Typically the silicone materials herein will be measured on the A or the D durometer scales, each of which has values spanning 0-100.

There are two broad categories of silicone, based on their method of synthesis: Platinum (addition) cured, and Tin (condensation) cured. These are also referred to as 2-base systems: either Sn-based or Pt-based. To form a 2-part liquid silicone: the base is mixed with the catalyst and then the mixture is stirred. Curing is possible at room temperature, or by warming the material up. When introducing a photochromic material, this is typically done by pre-mixing it with the base before adding the catalyst.

Platinum-cured silicones exhibit almost no shrinkage during curing, except when heated to accelerate cure. They are inhibition sensitive, particularly to nitrogen containing compounds like amines, the compounds on double-sided tape and some soaps, as well as to latex, sulfur, and tin. Platinum cured silicones are often used in medical devices because of their biocompatibility and high level of homogeneity. Platinum-catalyzed silicone manufacture is described in, for example: “Homogeneous Platinum Catalysts”, MacMillan, J. H., United Chemical Technologies, Inc. (www.unitedchem.com); and, “Platinum Catalysis Used in the Silicones Industry”, Lewis et al., Platinum Metals Rev., 41:66-75 (1997), both of which are incorporated by reference in their entireties.

Tin-cured silicones shrink during curing, for example by giving off ethanol or methanol solvent, thereby causing shrinkage. If shrinkage is a problem, use 5%-8% catalyst, but curing will take a lot longer. These silicones have few or no inhibition problems. Most will cure in presence of sulfur clays and moist materials.

While the curing of the silicone compound (over which time the ingredients are mixed together, for example by stirring) is taking place, there may also be a degassing of the material. Degassing involves putting the silicone rubber resin under a vacuum chamber to remove air bubbles that were introduced during the stirring and which would lead to undesirable properties if they remained within the material. See, for example, www.silicones-inc.com/process.htm.

The “working time” (sometimes called “pot life”) of a silicone material is the period of time that a reacting composition remains suitable for processing, after reaction-initiating agents have been mixed together. The physical properties of the silicone mixture are slowly changing from liquid to solid during this time. During the working time, the mixed silicone resin is still in liquid form and can be placed into a mold for casting. In general, silicone rubber resin pot life can be extended by lowering the temperature. After the working time, the silicone resin mixture becomes sticky and gummy, and therefore less easy to shape. For example, Mold Star 15 Slow, available from Smooth-on (www.smooth-on.com/tb/files/MOLD_STAR_{—}15_{—}16_{—}30_TB.pdf) has a working time of 50 minutes at room temperature.

### Silicone Rubber

Silicone rubber is an elastomer (rubber-like material) composed of a silicone, and can be used to form the photochromic materials described herein. Silicone rubber is generally amorphous, malleable, but non-reactive, stable, and resistant to extreme environments and temperatures from −55° C. to +300° C.

Silicone rubbers are often supplied as two components that need to be mixed, and may contain fillers or other ingredients such as coloring agents to adjust their properties or reduce cost.

The relatively long working time of silicone rubber resin allows additional tasks such as degassing and casting to be performed. It can be particularly advantageous if the mixture fully is degassed before it is transferred into the mold. Air bubbles are often introduced into the silicone rubber resin during the mixing process. By removing as much of the extra air as possible, the final silicone rubber will pick up better detail and have stronger physical properties.

Exemplary silicone rubber materials for use herein, in connection with making a photochromic silicone material, include but are not limited to: Rhodorsil RTV-3040, a translucent two component addition cure silicone rubber compound available from BlueStar Silicones (www.bluestarsilicones.com) and having Shore A hardness 38; the VST (VerSiTal) line of Platinum silicone elastomers, translucent addition cure silicones available from Factor II Inc. (www.factor2.com) having variable cure times, and Shore A hardness 30-38, and based on polymethylvinylsiloxanes and polymethylhydrogensiloxanes.

### Photochromic Molecules

One mechanism of operation of a photochromic molecule is that, under the influence of UV light, the molecule changes shape, for example, opening up from a twisted figure-8, or ‘S’-shaped, structure into an open, planar, form. In some embodiments, the open form may be brightly colored and is a very effective absorber of visible light, whereas the twisted form is clear or colorless. In other embodiments, vice versa applies: the twisted structure is brightly colored whereas the planar form is not. In still other embodiments, both the open and planar forms are good absorbers of visible light, but in different portions of the visible spectrum, so that a color change accompanies the absorption of UV light.

The color change, or the change between colored and colorless, derives from a reversible equilibrium; when the source of radiation is removed, the molecule will revert back to its unactivated or “resting” state. If necessary, a photochromic dye can be made to change between particular desired colors by combination with a permanent pigment.

Photochromic molecules belong to various classes, such as, but not limited to: triarylmethanes, stilbenes, azastilbenes, nitrones, fulgides, spiropyrans, naphthopyrans, spiro-oxazines, quinones. Any of these classes of molecule can be used to form the silicone based materials described herein.

Particularly preferred classes of photochromic molecule are the spiropyrans, spirooxazines, and naphthopyrans.

The photochromic compound can be available, or stored prior to use, in either powder or solution form.

One of the oldest, and perhaps the most studied, classes of photochromes are the spiropyrans. Very closely related to these are the spiro-oxazines. For example, the spiro form of an oxazine is a colorless leuco dye; the conjugated system of the oxazine and another aromatic part of the molecule is separated by a spa-hybridized “spiro” carbon. After irradiation with UV light, the bond between the spiro-carbon and the oxazine breaks, the ring opens, the spiro carbon achieves sp²-hybridization and becomes planar, the aromatic group rotates, aligns its π-orbitals with the rest of the molecule, and a conjugated system forms which has the ability to absorb photons of visible light, and therefore appear colorful. When the UV source is removed, the molecules gradually relax to their ground state, the carbon-oxygen bond reforms, the spiro-carbon becomes sp³ hybridized again, and the molecule returns to its colorless state.

This class of photochromes in particular is thermodynamically unstable in one form and reverts to the stable form in the dark unless cooled to low temperatures. Their lifetime can also be affected by exposure to UV light. Like most organic dyes they are susceptible to degradation by oxygen and free radicals. Incorporation of the dyes into a polymer matrix, adding a stabilizer, or providing a barrier to oxygen and chemicals by other means prolongs their lifetime.

One preferred class of dye material suitable for use herein is plastisol. See, for example, U.S. Patent Application Publication No. 2008-021141, published Jan. 24, 2008, incorporated herein by reference. Plastisols are ink formulations that have found application to dyeing textiles and fabrics. The inks comprise PVC particles suspended in an emulsion (a plasticizer), and are available in a variety of colors, as determined by a dye component contained within. The ink is not water soluble and, rather than being dried or bonded on to a material, the inks are applied to a substrate with a curing process, therefore making them suitable for use with the silicones described herein. The curing process for a plastisol usually involves some heating. Background information about plastisol inks, and their method of application, can be found at: www.unionink.com/articles/geninfo.html, incorporated herein by reference.

Exemplary photochromic plastisol inks are available from Union Ink Co. (See, e.g., product guide at www.unionink.com/.) These inks are colorless but change to a predefined color when irradiated with UV light. For example, certain inks from Union Ink Co. have the following product identifiers and colors, and are suitable for use with silicones herein: PHOT/PHOE-2000 (yellow; PANTONE® 135 or 136); PHOT/PHOE-4025 (purple; PANTONE® 260); PHOT/PHOE-5000 (blue; PANTONE® 647 or 653). Formulas for additional colors can be obtained by mixing, as follows (ratios by weight): tan (similar to PANTONE 722C)—PHOT-2000 86.2%: PHOT-4025 13.8%; royal purple (similar to PANTONE 2665C)—PHOT-4025 75%: PHOT-5000 25%; green (similar to PANTONE 5777C)—PHOT-2000 67.6%: PHOT-5000 32.4%; mocha (similar to PANTONE 730C)—PHOT-2000 67.6%: PHOT-4025 32.4%; red violet (similar to PANTONE 507C)—PHOT-2000 58.8%: PHOT-4025 25.0%: PHOT-5000 16.2%; mustard (similar to PANTONE 142C)—PHOT-2000 93.2%: PHOT-5000 6.8%; forest green (similar to PANTONE 5773C)—PHOT-2000 55.6%: PHOT-5000 44.4%.

Another preferred form of photochromic molecule is the Reversacol™ photochromic dye range, available from Vivimed Labs (see, e.g., www.vivimedlabs.com/vivimed-products/reversacol-photochromic-dyes/?page=vivimed-products&value=reversacol-photochromic-dyes), and also from James Robinson Ltd., Huddersfield, UK, (see www.jamesrobinson.eu.com). Reversacol™ dyes are available in powder form and, when used in organic plastic materials such as polyolefins, acrylics, styrenes, polyurethanes, rubbers, polyvinylbutyrals, and PVC as well as ink formulations, are typically mixed in with a resin before being UV- or thermally cured. They are available in a variety of colors and can be used with silicone substances as described elsewhere herein. These dyes are also not water-soluble, a fact which improves their compatibility with silicone materials.

The photochromic Reversacol™ dyes, are generally based on two major families of photochromic molecules; spiroxazines and naphthopyrans. These molecules also achieve their color changes via a change of shape that occurs in the influence of UV light. Some members of the family can be activated by visible light, and therefore function in situations where some portion of the UV spectrum is blocked, e.g., by certain types of glass. The type of structural equilibrium for these two families of molecules are illustrated as follows:

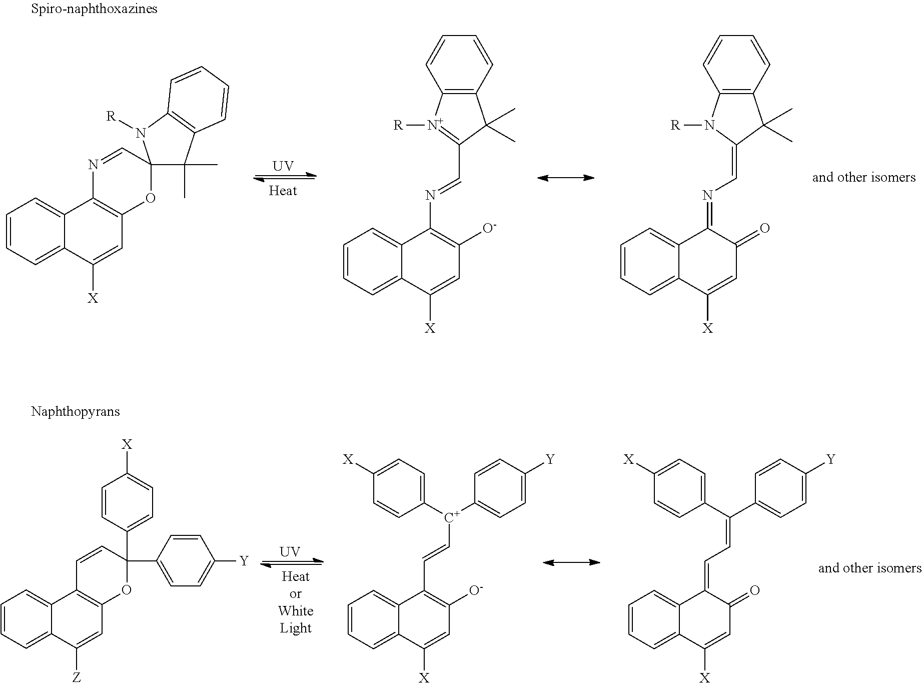

Reversacol dyes may experience a color shift when place into a resin, based largely on steric interactions between the dye molecules and those of the surrounding matrix. If the matrix is itself too inflexible, the dyes may not exhibit their photochromic behavior.

Other exemplary dyes that can be used with the silicone materials herein are described in Vikova and Vik, “Alternative UV Sensors Based on Color-Changeable Pigments”, Adv. In Chem. Eng. and Sci., 1, 224-230, (2011), incorporated herein by reference. Such dyes include, but are not limited to: 3,3,5,6-tetramethyl-1-propylspiro [indoline-2,3′[3H] pyrido [3,2-f][1,4]benzoxazine]; methyl 2,2,6-tris(4-methoxyphenyl)-9-methoxy-2H-naphtho-[1,2-b]pyran-5-carboxylate; methyl 2,2-bis(4-methoxyphenyI)-6-acetoxy-2H-naphtho-[1,2-b]pyran-5-carboxylate; and 1,3,3,5,6-Pentamethyl(indoline-2,3′-[3H]naphtho [2,1-b] [1,4] oxazine).

Still other photochromic substances that may be incorporated into silicone based materials as described elsewhere herein include products available from LCR Hallcrest (Glenview, Ill.; see, e.g., www.colorchange.com/photochromic, and www.hallcrest.com/pci.cfm). These dyes are not water soluble, and are colorless until they experience UV light, whereupon they change color. Photochromic Plastisol Ink, a photochromic dye in PVC plastisol at a level of 1-10%, is available in colors: aqua, green, gold, magenta, orange, pink, plum, red, rose, turquoise, and yellow. An exemplary product is referred to as Photochromic Plastisol Screen Ink UI53000. Other photochromic products available from LCR Hallcrest include powders and slurries, identified by product name as Photochromic Powder and Photochromic Plastisol Ink (R43). Pantone Matching System approximations for some available colors are: Blue—2995U; Magenta—2405U; Orange—1495U; Purple—254U; Red—1797U; and Yellow—116U.

The silicone-based materials described herein and processes for making the same can also work with other photochromic pigment families.

Different photochromic pigments have different activation ultraviolet radiation ranges from wavelengths between 500 nm to 250 nm. Preferred photochromic silicone based materials can be fully activated in ultraviolet radiation with wavelength between 400 nm and 250 nm.

The speed of the color change during the reversion phase depends on the nature of the photochromic molecule, and is also slightly dependent on pigment concentration. The pigment concentration can be controlled by the organic solvent used. For example, organic solvents such as toluene, THF and xylene can dissolve more photochromic pigments per unit volume compared with, say, ethyl acetate.

The lifetime of photochromic silicone rubber materials as described herein can be extended with stabilizer such as HALS-type, anti-oxidants, and other UV-absorbers that do not interfere with the indicating properties of the photochromic compound.

It is possible to combine two or more different photochromic pigments to create a new color, activation time, and deactivation time. For example, combining a yellow photochromic pigment with a dark blue photochromic pigment will create a green photochromic pigment with a new activation ultraviolet wavelength and deactivation time.

Based on the examples listed herein, photochromic solutions created with organic solvents (THF, xylene, acetone, ethyl acetate and etc.) can work with both condensation cured and addition cured silicones. Room temperature (between 65° F. and 73° F.) vulcanized silicone rubber. Platinum base silicone rubber can be cured faster in higher temperature.

In some embodiments, a photochromic dye based on plastisol ink can pre-mixed with a Reversacol™ photochromic dye (available in powder form). For use in coating or ink, a soft resin works best. For example, soft acrylics, polyurethanes, polyvinyl butyrals [PVB] and PVC [with acidity controlled]. This is particularly so if there is a plasticizer present to increase the flexibility. The key is the flexural modulus of the resin.

In some instances, a powder form dye may change color on mixing with an ink. Sometimes as much as a 20 nm shift can be observed in the peak absorption when the dye is put into different systems, or if the additives are changed.

The color of the pigment might also shift from its original color to another color when it is absorbed into a matrix material, such as the silicone matrix. For example, the Reversacol™ dye having color palatinate purple is a strong deep purple colour in extruded LDPE plastic, and a blue colour within an optical lens monomer.

The plastisol dyes however have no, or only a slight color change, when incorporated into the silicone material, and are unlike Reversacol™ in that sense. The silicone may become hazy, or whitish in the un-activated state, but in general, when the plastiscol system is in use, there is less influence of matrix observed in the mixture compared with other systems.

Exemplary Applications

Applications of a silicone material, into which a photochromic substance has been incorporated, include but are not limited to: in the shoe industry—molds for shoe lasts; prosthetics—such as hearing aid holders; medical teaching aids—soft tissues, and synthetic skin; sculptures—glove molds for waxes; dental—models and molds in the lab; sports—molds to pour pewter fishing lures; foundry—molds for lost wax process; giftware—molds for giftware, such as doll parts, flower pots; movie industry—costumes, props and masks; military—molds for training guns; fireplace manufacturers—molds for fireplace surrounds; rapid prototyping—molds for models; aerospace—platinum-cured silicone can post cure to a Shore hardness of 75A, arm rest molds for heat cured urethanes; industrial—plugs for sinks; architectural—molds for moldings, gargoyles, trees, light stands; pottery—molds for plaster molds; lubrication—high viscosity silicone oil, e.g., sprinkler uprights for smooth raising and lowering.

The photochromic silicone material can also be used for coating on other materials, such as windows, and other glassware.

### EXAMPLES

### Example 1

### Platinum-Based Silicone Rubber With Photochromic Powder

This example describes certain steps involved in creating a photochromic silicone rubber material starting from the photochromic powder Reversicol™ (available from Vivimed Labs), based on a platinum-curing process. It is to be understood that the initial steps of preparing various components may be performed in any order, or simultaneously with one another.

Some silicone resin systems are very sensitive to the ratio between the base and catalyst. If the ratio of the two solutions is not accurate, the silicone rubber will not cure probably, and the rubber might, for example, feel gummy or sticky on its surface. Some silicone resin systems suggest to measure the ratio of the base and catalyst by weight, and some might require the ratio to be measured by volume.

The first step is to create a solution of the photochromic material. For example, 1 g of Reversacol™ photochromic powder is dissolved into 100 ml of ethyl acetate. The photochromic powders can also be dissolved in other organic solvents such as organic polymers, and non-polar aromatic solvents such as toluene, THF (tetrahydrofuran), xylene, and acetone.

In a second step, Factor II VST-30 platinum RTV silicone rubber is prepared. The silicone comprises two parts: the base (Part A), and catalyst (Part B).

The base (Part A) is measured out accurately before use. The solution of the photochromic dye with ethyl acetate is added to Part A of the silicone material. The total amount of the photochromic solution added into the silicone compound should be between 0.5% and 10% by volume. If the photochromic pigment concentration level is higher than suggested, it may degrade the pigment performance and the photochromic molecule might not change color when exposed to Ultraviolet Light.

The catalyst container (Part B) may be shaken well before use, if applicable. Some silicone rubber resin systems contain thinner in the catalyst portion, to make it more fluid. Depending on how long the catalyst portion has been sitting prior to use, a thin layer or solution floating on top of the catalyst solution may form. Shaking well before use will ensure a homogenous mixture, and best results.

The desired amount of base is weighed into a clean mixing container. Then the proper amount of catalyst is weighed into the container and the ingredients mixed together by stirring. Parts A and B are mixed in a 10:1 ratio by weight.

If the amount of the organic solvent is more than 10% of the total volume of the silicone rubber compound, it will degrade the silicone rubber performance. Degraded silicone might not cure properly and may remain in a gummy form.

The silicone compound will cure at room temperature within about 30 minutes. (The process can be reduced to as little as 5 minutes if the system is heated.) The actual curing time is representative and typically varies depending on the nature of the platinum-based silicone rubber system.

The color of the Reversacol photochromic powder might be affected when it is incorporated into the silicone rubber material. For example, the photochromic compound has a creamy color in powder form, which turns into plum red when dissolved into an organic solvent such as ethyl acetate. The plum red color of the photochromic material may further change to light blue when mixed with the silicone compound. Such a color shift will not ordinarily affect the ability of the compound to activate in UV light.

Once cured, the photochromic silicone rubber compound can be used to make useful objects, for example by injection moulding, compression moulding, transfer moulding, vacuum moulding and similar techniques. During such processes, the temperature should be between 180° F. and 250° F. The pressure should be controlled between 0 psi and 60 psi.

### Example 2

### Tin-Based Silicone Rubber With Photochromic Powder

This example describes certain steps involved in creating a photochromic silicone rubber material containing the photochromic powder Reversacol by Vivimed, based on a tin-curing process. It is to be understood that the initial steps of preparing various components, prior to curing, may be performed in any order, or simultaneously with one another.

The steps of creating a solution of the photochromic material, mixing with the base (part A), preparation of the catalyst portion, and mixing the catalyst portion with the base, are as described in Example 1, with respect to platinum-cured silicone.

Silicone preparation: Prepare Douglas and Sturgess SR-1610. This is a two component room temperature vulcanizing, condensation (tin) cure silicone elastomer. Additional information can be found at: www.douglasandsturgess.com/PDFs/SR-1621_{—}1618_{—}1610-DS.pdf.

The silicone compound will cure in room temperature between 16 and 24 hours. Note that heat will not speed up the tin-based silicone rubber curing time.

As described with Example 1, the color of the Vivimed Reversacol photochromic powder might be affected when it is incorporated into the silicone rubber material.

Once cured, the photochromic silicone rubber material can be used to make other objects, as described for Example 1.

### Example 3

### Platinum Based Silicone Rubber With Photochromic Plastisol Ink

This example describes certain steps involved in creating a photochromic silicone rubber material containing the photochromic material Plastisol Ink, available from LCR Hallcrest. It is to be understood that the initial steps of preparing various components, prior to curing, may be performed in any order, or simultaneously with one another.

The silicone material used is: Bluestar platinum-based clear silicone rubber V-3040. The base (Part A) is measured out accurately before use. The solution of the photochromic dye prepared with Plastisol ink is added to Part A of the silicone material. The total amount of the photochromic solution added into the silicone compound should be between 0.1% and 5% by volume. (If higher, the silicone might not cure properly.)

The catalyst container (Part B) is shaken well before use.

The desired amount of base is weighed into a clean mixing container. Then the proper amount of catalyst is weighed into the container and the ingredients mixed together by stirring. Parts A and B are mixed in a 10:1 ratio by weight.

The silicone rubber has 2 hours working time and 24 hours curing time at room temperature.

The platinum-based silicone rubber will cure faster under heat. For best results, use of a silicone compound that has a longer pot time and a longer curing time is preferred. Silicone materials based on plastisol-based inks require application of heat to cure properly. For example, heating the mixture to between 200 and 250° F. for 5 to 20 minutes (depending on thickness) is effective.

Pressure can enhance the compound curing time and need to apply with caution. Pressure over 60 psi will degrade the color changing and possible permanently destroy the pigment within the silicone compound.

Once cured, the photochromic silicone rubber material can be used for low-pressure injection moulding, compression moulding, transfer moulding, vacuum moulding, and similar techniques.

The photochromic silicone rubber compound prepared with Plastisol ink experiences very little color shift effect of the photochromic material. For example, the plum red photochromic plastisol ink remains plum red in the final silicone rubber compound.

### Example 4

### Personal UV Active Silicone Wristband

Function: A UV active silicone wristband will change color when exposed to UV radiation, and it will change back to its original color when UV is no longer impinging upon it. A UV Active wristband can therefore provide a user with a visual alert for when UV radiation is present in their surroundings.

Advantages of such a UV active silicone wrist-band include that it is a non-electronic device and does not require batteries to operate. The wristband can work within harsh environmental conditions such as in snow and under water.

### Example 5

### Ultraviolet Radiation Indicator/Detector

A device that utilizes a photochromic silicone material will exhibit a change color when exposed to UV radiation, and therefore will act as a detector. The depth of the color change can indicate the level of exposure to the ultraviolet radiation. The material can be based on one or more of 4 different colors: for example, red, yellow, orange, and purple. Each color reacts to a specific range of radiation wavelength within the ultraviolet portion of the electromagnetic spectrum.

Advantages of such a device include that it is a non-electronic device, it can operate under water, and it can function within ranges of temperature normally experienced by users, e.g., from the height of summer to the depth of winter. The device also is flexible enough to fit on an object with a non-uniform shape.

### Example 6

### Photochromic Window Shade

A photochromic window shade is fabricated as a thin silicone film that can be placed on a window. During the daytime, the film will absorb ultraviolet radiation and darken in color, thereby also letting less visible light through. At night, due to the absent of the ultraviolet radiation, the shade will revert to, and remain in, clear form. Such a window-shade can be applied to windows in buildings, to obviate the use of blinds, and to vehicles such as cars, trucks, and buses. Such shades have particular benefits for commercial vehicles that spend a lot of daylight hours on the road and are exposing their drivers to UV radiation for long periods of time.

Current window shades on the market might reduce the glare from the sun but cannot effectively block UV radiation. Some other sun shade designs will darken the windows permanently, thereby affecting driver visibility at night, but might still not improve the windows' ability to block ultraviolet light.

### Example 7

### Photochromic Wine Sleeve

Ultraviolet light can impact wine in a similar way to excessive heat and it can cause oxidation of compounds such as tannins in the wine. See, for example, www.wrap.org.uk/sites/files/wrap/UV%20&%20wine%20quality%20May%2708.pdf, an article which describes modifying the glass from which wine bottles are made in order to filter out harmful wavelengths of light. Most wine glass bottles offer some protection from the ultraviolet light that can affect wine quality, but given the length of time over which a lot of wine is stored, a means of protecting the very large existing inventory of wines is also desirable. A photochromic wine sleeve can be designed as a sheet or film that wraps around the bottle. When the wine sleeve is exposed to UV radiation, it absorbs the UV radiation and darkens in color to help preserve the wine. Its change of color also serves as a visual indicator of the presence of UV light in the surrounding.

A photochromic wine sleeve is semi-transparent and allows a user to read the wine label without removing the bottle from the sleeve. When the photochromic wine sleeve is exposed to UV radiation, or radiation of wavelength around 500 nm, it will absorb the UV radiation and darken in color to prevent excessive UV light from going through it. The color change provides a visual indicator. The silicone material is stretchable and allows the wine sleeve to fit a range of bottle shapes and sizes.

### Example 8

### Photochromic SilNylon

SilNylon is a useful material that is waterproof and lightweight. A photochromic SilNylon, that has been modified to include a photochromic substance, will have the same attributes, in addition to UV radiation absorbing properties and a shift in color to add an aesthetic appeal and indicate that UV absorption process is enabled.

Currently, SilNylon in the market does not have any UV blocking properties. Nylon itself is very sensitive to UV rays. UV resistant Silicone mixed with the nylon helps to increase its tensile strength, and although the silicone itself is UV resistant (meaning it does not degrade due to UV exposure), it allows UV to pass through and damage the nylon. A photochromic SilNylon has UV absorbing properties due to the photochromic material embedded in the silicone, and helps to shield the sensitive nylon from damage. Another effect that it has is the ability to change or shift color from a clear or transparent state. This color change is an indication of the UV absorption enabled and working. SilNylon is currently used in parachutes, hot air balloons, ropes, tents, ropes, and bags. Another use is clothing wherein the UV absorbing properties not only protect the material but also provide a degree of UV protection for the wearer. The material of this example also absorbs both UV and visible light.

All references cited herein are incorporated by reference in their entireties.

The foregoing description is intended to illustrate various aspects of the instant technology. It is not intended that the examples presented herein limit the scope of the appended claims. The invention now being fully described, it will be apparent to one of ordinary skill in the art that many changes and modifications can be made thereto without departing from the spirit or scope of the appended claims.

What is claimed:

1. An composition, comprising:
a photochromic dye non-covalently integrated into a silicone substrate.

2. The composition of claim 1, wherein the silicone is a silicone rubber.

3. The composition of claim 1, wherein the silicone is polydimethylsiloxane.

4. The composition of claim 1, wherein the photochromic dye is selected from the group consisting of: triarylmethanes, stilbenes, azastilbenes, nitrones, fulgides, spiropyrans, naphthopyrans, spiro-oxazines, and quinones.

5. The composition of claim 1, wherein the photochromic dye is selected from the group consisting of: spiropyrans, spiro-oxazines, and naphthopyrans.

6. The composition of claim 1, wherein the photochromic dye is a Reversacol™ dye.

7. The composition of claim 1, wherein the photochromic dye is a plastisol ink.

8. The composition of claim 1, wherein the composition is homogeneous.

9. A medical device comprising a composition of claim 1.

10. A wristband comprising a composition of claim 1.

11. A method of making a photochromic material, the method comprising:
dissolve a powder of photochromic dye in an organic solvent;
mix the solution of photochromic dye with a silicone base material so that the photochromic dye comprises 0.5-10% of the mixture by volume;
add a catalyst to the mixture of dye and base in a ratio 1:10; and
cure the silicone mixture.

12. The method of claim 11, wherein the catalyst is tin.

13. The method of claim 11, wherein the catalyst is platinum.

14. A method of making a photochromic material, the method comprising:
mix a photochromic ink with a silicone base material so that the photochromic ink comprises 0.5-5% of the mixture by volume;
add catalyst to the mixture of dye and base in a ratio 1:10; and
cure the silicone mixture.
